(19) United States
(12) Patent Application Publication
(10) Pub. No.: US 2011/0192105 A1
(43) Pub. Date: Aug. 11, 2011

(54) LIGHTWEIGHT FLOOR SLAB

(76) Inventor: Ying Chun Hsieh, Fengyuan City (TW)

(21) Appl. No.: 12/998,176

(22) PCT Filed: Sep. 28, 2009
(86) PCT No.: PCT/CN2009/001093

§ 371 Date: Mar. 24, 2011

(30) Foreign Application Priority Data
Sep. 28, 2008 (CN) 200820133842.4

(51) Int. Cl. E04B 5/00; B32B 3/10; B23P 11/00

(52) U.S. Cl. 52/582.1; 428/138; 428/139; 29/897.34

(57) ABSTRACT

A lightweight floor slab comprises a meshy shuttering (1), a metal mesh (3) and cement mortars (2), wherein the meshy shuttering (1) and the metal mesh (3) are formed to a whole by filing the cement mortars (2).

### TECHNICAL FIELD

The present invention relates to a building material used in the construction field, and in particular to a lightweight floor slab for use in the building construction.

### BACKGROUND ART

The floor slab is a main component part of the deadweight of the building structure. Too great floor slab weight requires the very high supporting intensity for the members supporting the floor slab, members connected with the floor slab and other relevant building structures, thereby increasing the construction cost. Moreover, the increased weight of the floor slab and relevant building structures correspondingly lowers the quakeproof capability of the buildings.

At present, the floor slabs for construction projects in the domestic generally are concrete floor slabs. The floor slabs having a cast-in-place steel reinforced concrete structure in the country house have a thickness of about 10 cm. Such floor slabs are mainly made of cement, sand, stone and steel, and thus have great weight. At the same time, the floor slabs have the long finishing period and the relatively high cost. Further, it's hard for these overweight floor slabs to meet the quakeproof requirement of the country house.

In addition, although use of the bamboo-wood floors in the building can reduce the weight of the floor slabs, high prominence should be given to the fire prevention of the buildings.

Thereby, the current floor slabs for constructing are obviously faced with many inconveniences and defects in terms of their structure and usage, and it is desired to improve them. In order to solve the problems in the constructing floor slabs, the manufacturers have racked their brains to seek for the solution. However, the proper designs do not come out for a long time, and the general products do not have the appropriate configuration to solve the above problems. Obviously, the relevant persons are eager for the solution of these problems.

In view of the above defects existing in the current floor slab for constructing, the present inventor creates a lightweight floor slab of a novel structure by using his rich practice experiences and professional knowledge, combing the application of theory and actively performing the research and innovation, and improves the current floor slab for constructing, thereby bringing more practicality and greatly lowering the weight of the floor slab. After a lot of research, experimentation and improvement, the present invention of great practical value is finally created.

### SUMMARY OF THE INVENTION

The main object of the present invention is to overcome the defects of the current floor slab for constructing, such as great deadweight and complex manufacturing technology, and to provide a novel lightweight floor slab. The technical problem to be solved is to lower the weight of the floor slab to make it more practicable and with the industrial utilization value.

Another object of the present invention is to provide a lightweight floor slab. The technical problem to be solved is to reduce the usage amount of the steel during the process of manufacturing the floor slab, thereby reducing the cost of the floor slab and simplifying the use process and manufacturing technology thereof.

Yet, another object of the present invention is to provide a lightweight floor slab, and the technical problem to be solved is to reduce the thickness of the floor slab to make it more practicable.

The objects of the present invention and the addressed technical problems can be achieved or solved by the following technical solutions. In accordance with the present invention, a lightweight floor slab is provided that consists of a meshy shuttering, a metal mesh and cement mortars, wherein the meshy shuttering and the metal mesh are formed to a whole by filling cement mortars.

The objects of the present invention and the addressed technical problems can be achieved or solved by the following technical measures:
the lightweight floor slab, wherein the meshy shuttering comprises mesh battens and mesh faces;
the lightweight floor slab, wherein the mesh battens are V-shaped;
the lightweight floor slab, wherein the mesh faces are provided with punched holes thereon;
the lightweight floor slab, wherein dental laminas of meshy shuttering are arranged on side edges of the punched holes;
the lightweight floor slab, wherein the dental laminas of meshy shuttering are formed during the punching process;
the lightweight floor slab, wherein the lightweight floor slab is secured on a purline when in use;
the lightweight floor slab, wherein the lightweight floor slab is secured on the purline by self-drilling screws; the lightweight floor slab, wherein the purline is C-shaped lightweight steel

In virtue of the above technical solutions, the claimed lightweight floor slab has at least the following advantages:
(1) The meshy shuttering used in the lightweight floor slab is a perforated plate, and the dental laminas formed after the perforating are helpful to increase the bonding intensity between the cement mortar and the meshy shuttering. Steel bars are not necessary when using such a type of perforated plate, thereby reducing the usage amount of steel and simultaneously providing great intensity.
(2) The thickness of the claimed lightweight floor slab usually is 3-4 cm. Compared with the current concrete floor slab with a thickness of 10 cm, the thickness of the lightweight floor slab is greatly reduced, thereby reducing the usage amount of the concrete and making the claimed floor slab lighter.
(3) During the actual use, the construction procedure of the claimed lightweight floor slab is simplified.
(4) For the claimed lightweight floor slab, there is no need to disassemble the meshy shuttering so as to reduce the manufacture procedure of the floor slab.

In conclusion, the claimed lightweight floor slab of special configuration is more adapted for practicality thanks to the advantages of lowering the weight of the floor slab, reducing the usage amount of steel during the process of the making the floor slab, lowering the production cost of the floor slab, and simplifying the use process and manufacturing technology of the floor slab. The same kind of the product does not disclose or use the similar structural design, and thereby the claimed lightweight floor slab is novel indeed, and makes a great improvement on the structure and function, achieves the great technical advancement and produces the good and practical effects. The lightweight floor slab has many increased functions relative to the current floor slab so as to make it more adapted for the practicality and have the wide commercial utilization value. Therefore, the claimed lightweight floor slab is a novel, advanced and practical design.

The above description is only a generalization for the technical solutions of the present invention. To understand the technical means more clearly and carry out the invention according to the description, the preferred embodiments of the invention are described hereinafter in conjunction with the drawings.

Here is the specific structure of the invention as described by the embodiments and the drawings.

### BRIEF DESCRIPTION OF THE DRAWINGS

FIG. 1a is an overall schematic view of the meshy shuttering in the embodiments of the invention;

FIG. 1b is a local enlarging view of the meshy shuttering shown in FIG. 1a;

FIG. 1c is a cross-sectional schematic view of the meshy shuttering in the embodiments of the invention;

FIG. 1d is a schematic view of the dental laminas arranged in the meshy shuttering in the embodiments of the invention;

FIG. 2a is a schematic view after the grooves on the bottom surface of the meshy shuttering are floated with a layer of mud;

FIG. 2b is a local section schematic view of FIG. 2a;

FIG. 3 is a schematic view of adhering a metal mesh to the meshy shuttering after the grooves on the bottom surface of the meshy shuttering are floated with the mud layer;

FIG. 4a is an overall schematic view of the claimed lightweight floor slab;

FIG. 4b is a local section schematic view of FIG. 4a;

FIG. 5 shows an applicable embodiment of the lightweight floor slab.

1: a meshy shuttering; 2: a layer of cement mortar; 3: a metal mesh; 4: mesh battens 5: mesh faces; 6: dental laminas; 7: a cement plastering layer; 8: purline; 9: punched holes

### BEST MODE OF CARRYING OUT THE INVENTION

In order to further expound the technical means adopted for achieving the objects of the invention, the mode of carrying out the claimed lightweight floor slab and its structure, characteristics and effects are described in detail hereinafter in combination with the drawings and embodiments.

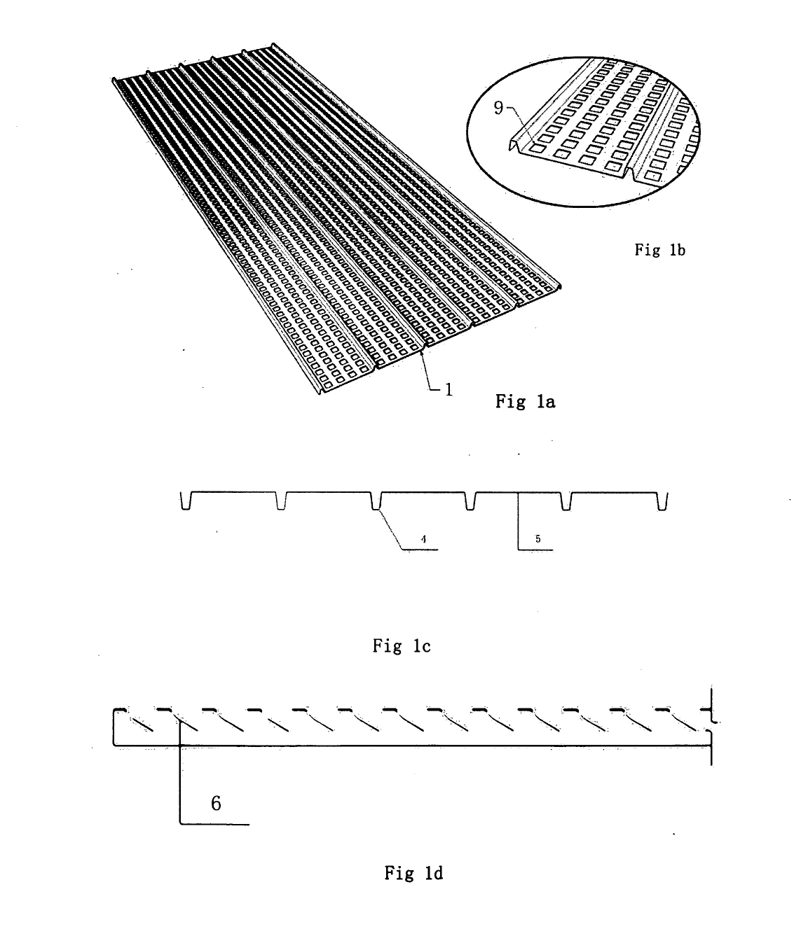

Referring to FIGS. 1a, 1b, 1c and 1d, the meshy shuttering 1 of the lightweight floor slab in a preferred embodiment of the invention mainly includes mesh battens 4 and mesh faces 5, wherein punched holes are provided on the mesh faces 5, and dental laminas 6 are provided on the side edges of the punched holes. The said mesh battens 4 may be V-shaped mesh battens or others of suitable shape.

In the preferred embodiment, a sheet of the complete meshy shuttering 1 comprises the continuously raised V-shaped mesh battens 4 and the steel mesh faces 5. The V-shaped mesh battens 4 that are arranged in a continuous and parallel manner are the main source of intensity of the meshy shuttering 1. The meshy shuttering 1 can be arc-like curved in a direction parallel to the V-shaped. The regular punched holes are provided on the mesh faces 5, and the raised dental laminas 6 on the punched holes can intensify the bonding strength between the meshy shuttering 1 and the materials.

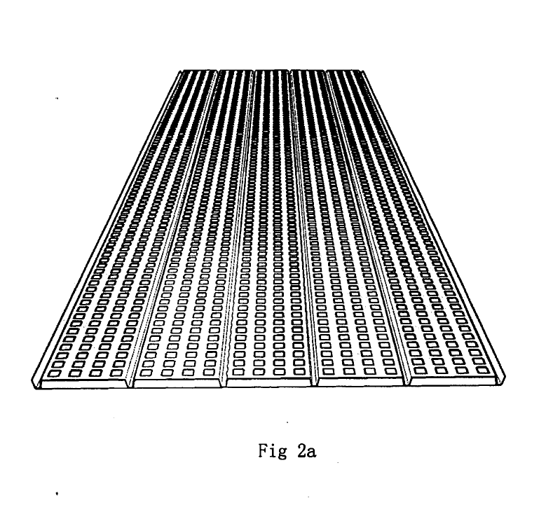

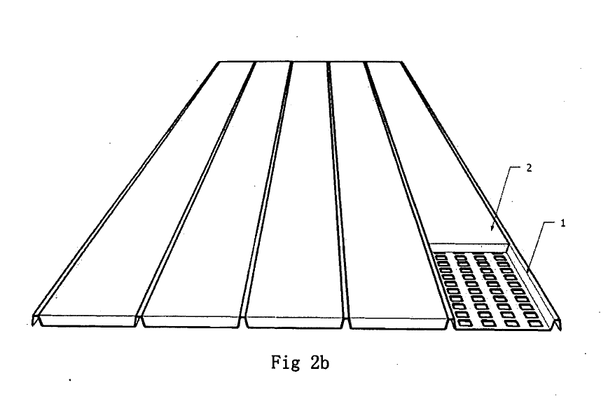

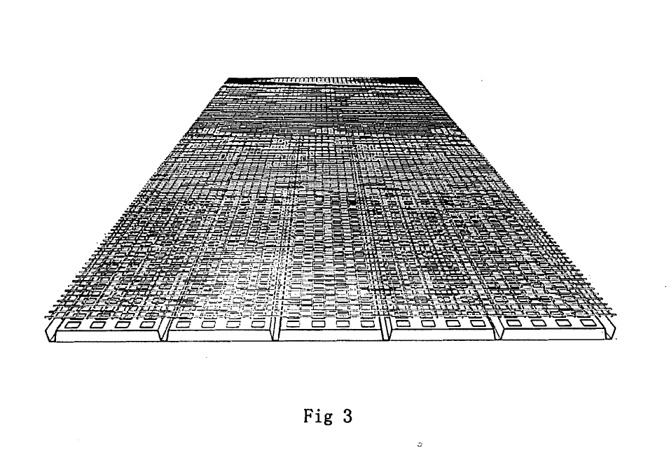

Referring to FIGS. 2a and 2b, the bottom surface of the meshy shuttering 1 of the lightweight floor slab in the preferred embodiment of the invention is coated with a cement mortar layer 2, which is flush with grooves on the bottom surface of the meshy shuttering. Referring to FIG. 3, after the front surface of the meshy shuttering 1 of the lightweight floor slab in the preferred embodiment of the invention is coated with a cement mortar layer 2 with a certain thickness, the metal mesh 3 is adhered thereto.

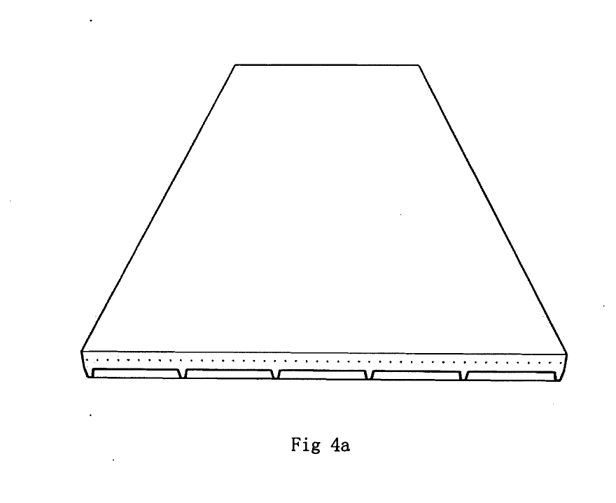

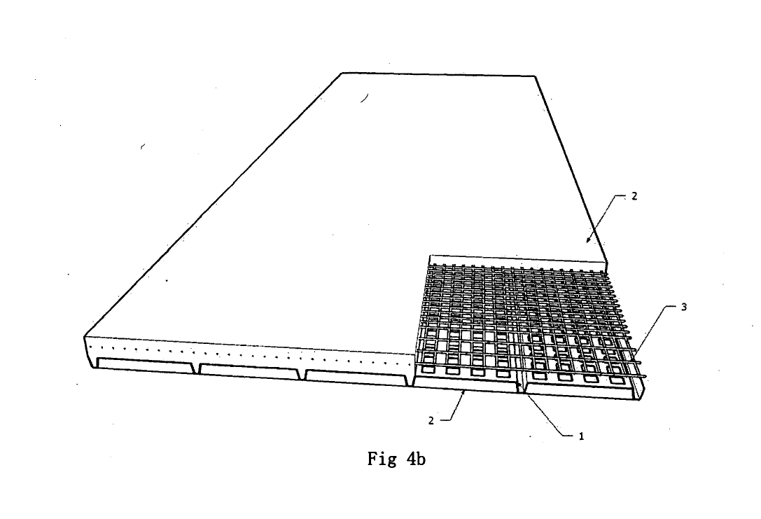

Referring to FIGS. 4a and 4b, they are the overall schematic view and the local section schematic view of the lightweight floor slab respectively in the preferred embodiment of the invention.

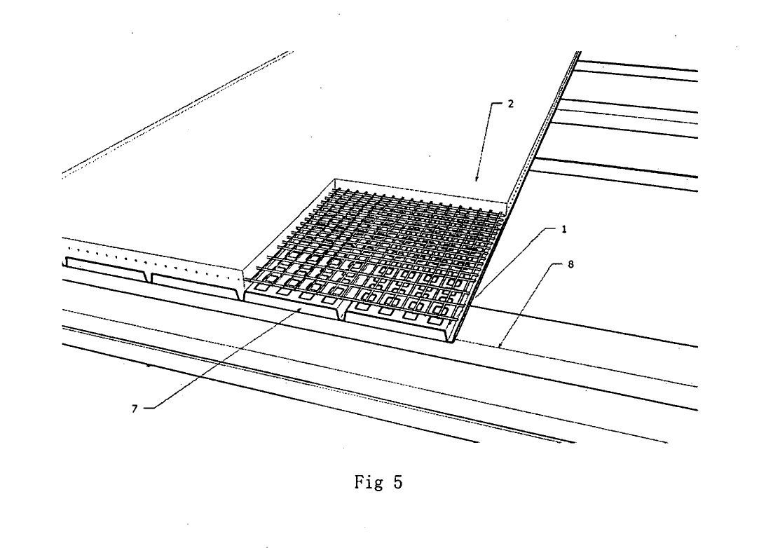

Referring to FIG. 5, it shows an applicable embodiment of the lightweight floor slab. In the preferred embodiment, there is no need to disassemble the meshy shuttering 1 during the actual use. The meshy shuttering may be steel or other metal materials, and the metal mesh 3 may be an electrically-welded steel mesh. During the manufacturing process of the lightweight floor slab, the bottom surface of the meshy shuttering is coated with the cement mortar, and the meshy shuttering after reaching certain dryness and hardness is turned and placed on C-shaped steel purline, and then fixed at the V-shaped groove places by self-drilling screws (not shown). The layer of cement mortar is plastered on-site, and the electrically-welded steel mesh is within the layer of cement mortar. The total thickness of the lightweight floor slab is 3 cm, and this can reduce the weight of the concrete floor slab as far as possible.

The combined plate after reaching proper hardness is turned over and placed on the C-shaped steel purline, with the V-shaped grooves opening upwards. The self-drilling screws pass through the bottoms of the V-shaped grooves to be fixed with the C-shaped steel purline.

The cement mortar is evenly dispersed on the top surface of the meshy shuttering on-site, and then compacted. The electrically-welded mesh is sandwiched in the cement mortar to form a concrete combined plate, with a total thickness of 3 cm.

The inventive point of the invention lies in that the meshy shuttering is mainly used for manufacturing the floor slab of the lightweight steel-structure building.

The claimed lightweight floor slab formed by the above processes brings the technological innovation, and has many redeeming features for a person skilled in the art. Thereby, the lightweight floor slab represents technical progress.

The above description is the basis concept of the invention. However, in the technical field of the present invention, other operable embodiments can be improved by means of the basis technical knowledge. Here, the substantive technical solution of the invention is sought for patent protection, and its scope of protection shall cover all the variations having the above technical features.

The above description is only a preferred embodiment of the invention, rather than a limit to any forms of the invention. Although the particular embodiment of the present invention has been described above, it will be apparent to those skilled in the art that various changes and modifications can be made without departing from the spirit of the present invention. Any changes and modifications to the above embodiment according to the technical essence of the present invention and without departing from the spirit of the present invention shall be embraced within the technical solution of the present invention.

1. A lightweight floor slab, characterized in that the floor slab consists of a meshy shuttering, a metal mesh and cement mortars, wherein the meshy shuttering and the metal mesh are formed to a whole by filing the cement mortars.

2. The lightweight floor slab according to claim 1, characterized in that the meshy shuttering comprises mesh battens and mesh faces.

3. The lightweight floor slab according to claim 2, characterized in that the mesh battens are V-shaped.

4. The lightweight floor slab according to claim 2, characterized in that the mesh faces are provided with punched holes thereon.

5. The lightweight floor slab according to claim 4, characterized in that dental laminas are arranged on side edges of the punched holes.

6. The lightweight floor slab according to claim 5, characterized in that the dental laminas are formed during the punching process of the mesh faces.

7. The lightweight floor slab according to claim 6, characterized in that the lightweight floor slab is secured on a purline when in use.

8. The lightweight floor slab according to claim 7, characterized in that the lightweight floor slab is secured on the purline by self-drilling screws.

9. The lightweight floor slab according to claim 8, characterized in that the purline is C-shaped lightweight steel.

10. The lightweight floor slab according to claim 1, characterized in that the lightweight floor slab is secured on a purline when in use.

11. The lightweight floor slab according to claim 2, characterized in that the lightweight floor slab is secured on a purline when in use.

12. The lightweight floor slab according to claim 3, characterized in that the lightweight floor slab is secured on a purline when in use.

13. The lightweight floor slab according to claim 4, characterized in that the lightweight floor slab is secured on a purline when in use.

14. The lightweight floor slab according to claim 5, characterized in that the lightweight floor slab is secured on a purline when in use.

15. A lightweight floor slab comprising:
a meshy shuttering defining mesh battens and mesh faces;
a plurality of holes on the mesh faces;
a dental lamina on a side edge of one or more of the plurality of holes, wherein the dental lamina extend below a bottom surface of the meshy shuttering;
a bottom cement mortar layer on the bottom surface of the meshy shuttering;
a metal mesh on a front surface of the meshy shuttering; and
a front cement mortar layer on the front surface of the meshy shuttering, wherein the metal mesh is adhered to the front surface of the meshy shuttering via the front cement mortar layer.

16. The lightweight floor slab of claim 15, wherein the mesh battens are generally V-shaped, and are adapted to be secured to a purline.

17. The lightweight floor slab of claim 15, wherein the lightweight floor slab has a total thickness in the range of 3-4 cm.

18. A method of making a lightweight floor slab, comprising the steps of:
providing a meshy shuttering comprising mesh battens and mesh faces;
forming punched holes on the mesh faces;
forming dental laminas on a side edge of the punched holes, wherein the dental laminas extend below a bottom surface of the meshy shuttering;
coating the bottom surface of the meshy shuttering with a bottom cement mortar layer;
providing a metal mesh on the front surface of the meshy shuttering;
coating the front surface of the meshy shuttering with a front cement mortar layer, wherein the metal mesh is adhered to the front surface of the meshy shuttering via the front cement mortar layer.

19. The method of claim 18, further comprising the step of securing the lightweight floor slab to a purline after the first coating step and before the second coating step.

20. The method of claim 18, wherein the lightweight floor slab has a total thickness in the range of 3-4 cm.
